(19) United States
(12) Patent Application Publication
(10) Pub. No.: US 2018/0007849 A1
(43) Pub. Date: Jan. 11, 2018

(54) HYDROCULTURE SYSTEM

(71) Applicant: LIVING BOX LTD., Hofit (IL)

(72) Inventors: Mordehay Shlomo COHEN, Hofit (IL); Nitzan Sara SOLAN, Mikhemoret (IL)

(73) Assignee: LIVING BOX LTD., Hofit (IL)

(21) Appl. No.: 15/542,786

(22) PCT Filed: Jan. 11, 2016
(86) PCT No.: PCT/IL2016/050028

§ 371 Date: Jul. 11, 2017

Related U.S. Application Data
(60) Provisional application No. 62/102,034, filed on Jan. 11, 2015.

(51) Int. Cl. A01G 31/02; A01K 63/00; A01K 63/04; A01G 31/06; A01G 31/00

(52) U.S. Cl. CPC A01G 31/02; A01K 63/04; A01G 31/06; A01K 63/003; A01G 2031/006

(57) ABSTRACT

Provided is a planting cup for hosting growing plants, for use in conjunction with hydroculture systems, and a development for producing same. The planting cup may be configured with a side wall formed with a plurality of openings and extending between an open bottom base and an open top base. The planting cup may also be constructed out of a sheet of pliable material.

### TECHNOLOGICAL FIELD

The present discolors generally relates to the field of hydroculture, and more specifically it relates to systems, devices and methods for hydroculture plant growing.

Herein in the specification and claims the term hydroculture refers collectively to soilless culture systems and methods such as hydroponics, aquaponics, fogponics, aeroponics, and the like, i.e. to the art of growing of plants in a soilless medium, or an aquatic based environment, wherein plant nutrients are distributed via an aqueous solution or moist.

### BACKGROUND AND PRIOR ART

Hydroponics is a subset of hydroculture and is a method of growing plants using mineral nutrient solutions, in water, without soil. Growing terrestrial plants without soil was already published in 1627 and ever since the use of hydroponic systems and methods is increasing.

According to some publications, hydroponics is the fastest growing sector of agriculture and it is not unlikely that hydroponics will eventually dominate fresh produce food production in the future, in particular noting the many advantages of such systems and methods.

The growing interest and improvements in hydroponic farming result also in a growing number of patent literature.

For example, US2015150202 discloses a hydroponic system wherein plants are grown in adjacent rows of trays that are rotated within a pool of a nutrient solution. The roots of the plants are at least partly immersed in the nutrient solution. Each row includes a gap wide enough to receive a single tray from an adjacent row. Using three rows, the plants are planted only in one of the rows, and later the rotation is used to space the planted trays one tray apart. Each tray is a parallelepipedal block with apertures for supporting respective plants. The long sides of the blocks have protrusions for preventing adhesion of the blocks. Airlift pumping circulates the nutrient solution past the roots and maintains at least 80 percent dissolved oxygen saturation in the nutrient solution. A screen of parallel inflatable tubes provides adjustable shade above the pool.

U.S. Pat. No. 8,549,788 is directed to a hydroponic growing system including a nutrient reservoir and a planting tray having a perimeter air channel for floating on a liquid in the reservoir. A continuous planting trough is included in the planting tray for growing multiple plants in an un-segmented arrangement which is defined by a series of laterally spaced support arms extending across and underneath an opening in a support plate for carrying plant growth materials. The planting tray floats in the reservoir so that a majority of the planting trough is disposed above the liquid in the reservoir to allow for lateral air root growth. A flexible flange is carrier around the perimeter of the planting tray engaging the reservoir to form a light barrier between the planting tray and the reservoir. An air line passes into the reservoir which is connected to an air pump for introducing air into the liquid in the reservoir.

KR20150004397U relates to a two-level potting container made of sheet material by origami folding.

Acknowledgement of the above references herein is not to be inferred as meaning that these are in any way relevant to the patentability of the presently disclosed subject matter.

### GENERAL DESCRIPTION

A first aspect of the present disclosure is directed to a planting cup for hosting growing plants, for use in conjunction with hydroculture systems, said planting cup configured with a side wall formed with a plurality of openings and extending between an open bottom base and an open top base, wherein the planting cup is constructed out of a sheet of pliable material.

The first aspect of the present disclosure is further concerned with a pliable sheet material being a development of a planting cup for use in conjunction with hydroculture systems, said development configured for constructing therefrom a planting cup configured with a side wall formed with a plurality of openings and extending between an open bottom base and an open top base.

Any one or more of the following features, designs and configurations can be incorporated in a planting cup according to the present disclosure, solely or in various combinations thereof:

The bottom base of the planting cup is smaller then the top base, such that the side wall tapers towards the bottom base;

The sheet material can be made, for example, of Polypropylene (PP), Polyvinyl chloride (PVC);

The sheet material can be made of or comprise recycled material;

The sheet material can be homogeneous or it can be composite material, or reinforced material;

The sheet material, with at least some of its formations (e.g. apertures, elements of a fastening mechanism) can be formed by injection molding or by puncturing;

The three dimensional shape of the constructed planting cup can be retained by a fastening mechanism, or through embracing of wall portions of a cup receiving receptacle of the hydroculture systems;

The planting cup can have a cylindrical shape;

The planting cup can have a polyhedron shape;

The planting cup can have a truncated shape (frustum cone or frustum pyramid);

The planting cup can be symmetric or asymmetric about the longitudinal axis extending between the top base and the bottom base;

The top base and the bottom base of the planting cup can extend normal to a longitudinal axis of the planting cup, and parallel to one another, or any one of the top base and the bottom base can extend oblique with respect to said longitudinal axis;

The sheet material can comprise, e.g. by impregnation or by applying over the surface walls (directly or over a carrying sheet), different agents, such as anti pesticides, antifungal, UV retarding agents, hydrophobic agents, anti-algae agents, bio-film preventing agents (i.e. for preventing microbial or other living substances), anti bacteria agents, anti fugal agents, etc. nano-hydrophobic coating, disinfecting agents (e.g. chemical disinfectants), etc.;

The openings configured at the sheet material can assume any shape, e.g. circular, polygonal, elongate apertures, etc.;

The openings at the sheet material can be configured with a descending size extending from a top end towards a bottom end thereof;

The fastening mechanism can be a fastener flap extending at the side wall and configured for arresting within a corresponding fastener slit formed in the sheet material;

The sheet material can be configured with one or more fastener flaps and with one or more fastener slits, whereby the planting cup, at its erected configuration, can assume different geometrical shapes and sizes;

A fastener flap can extend from a side edge of the development, and configured for arresting within a slit adjacent an opposite side edge of the development;

The fastener flap and the slit can be disposed parallel to respective side edges of the development;

The length of the fastener flap can be greater than the length of the respective slit, with a projection at a bottom portion of the flap;

The fastening mechanism can be a hook and loop fastener, adhesive agent, magnetic elements, etc, whereby the sheet material can be readily constructed into the three dimensional planting cup;

The arrangement of the fastener mechanism can be such that only little force is required to open the fastening mechanism, to the extent that a developing root system can disengage the fastening mechanism, allowing expansion of the inside space of the planting cup;

Heat absorption of the planting cup can be reduced by manufacturing the sheet material or applying thereover a light color;

The bottom opening is configured to allow projection of substantially water roots, and the openings formed over the side wall of the planting cup are configured to allow projection of substantially air roots and for aerobic purposes;

The planting cup is configured with a securing mechanism for removable securing it within a respective cup opening configured at a planting cup carrying member, thereby securely positioning the planting cup within the cup opening either at a vertical or inclined position;

The securing mechanism can be, for example, a threading configured at an outside face of the planting cup, a snap-type engagement, friction engagement, etc.;

Friction engagement can be enhanced by configuring an outside face of the planting cup with projections;

The planting cup can be nestable within like planting cups;

The planting cup can be manufactured from a bio-degradable material;

An outside surface of the planting cup can be configured for receiving within a cup opening of a planting cup carrying member having a flat surface or a curved surface.

According to a second aspect of the present disclosure there is a planting cup carrying member, configured for removably retaining a plurality of planting cups or seedlings, said planting cup carrying member is a planar member having top face and a bottom face, with a plurality of cup openings disposed through said carrying member, each configured to support therein a planting cup, wherein the carrying member is further configured with a flotation arrangement for retaining a substantially fixed distance between the bottom face and a water bed surface, and further wherein an air flow passage extends at least at the bottom face of the vicinity of each cup opening.

It is appreciated that the planting cup carrying member can be used for accommodating a plurality of planting cups or seedlings, i.e. without the cup.

Any one or more of the following features, designs and configurations can be incorporated in a planting cup carrying member according to the present disclosure, solely or in various combinations thereof:

The planting cup carrying member can be configured for removably supporting a plurality of planting cups and/or seedlings, without planting cups;

Planting cups and seedlings can be slidingly displaced within recessed cup openings;

The planting cup carrying member can be made of a material having a specific gravity less than water;

The planting cup carrying member can be configured with floating elements articulated thereto (integral therewith or attachable thereto);

The planting cup carrying member can be in the form of a sheet of material stretched over a support frame;

The planting cup carrying member can be made of a rigid board of material;

The planting cup carrying member can be made of foamed material e.g. Polyethylene, Polyurethane, etc.;

The rigid board can be configured at a bottom face thereof with a depressed channel extending between at least neighboring cup openings;

The cup openings of the planting cup carrying member can be disposed along a linear matrix, wherein a bottom face of the rigid board can be configured with a flow channel extending along a linear path between respective opposite ends of the planting cup carrying member;

A bottom face of the planting cup carrying member can be configured with a step-like wave cross section. According to a particular example the bottom face has a square step-like wave cross section, with cup openings disposed at an top apex;

The planting cup carrying member comprises a plurality of cup openings, at least some of which can be selectively neutralized by blocking, or sealing, to thereby allow spacing between neighboring active cup openings;

The cup openings configured at the board of material can be cylindrical or have a tapering cross section;

The cup openings of the planting cup carrying member can be configured with a planting cup engagement arrangement, for securing a planting cup within a respective cup opening;

The planting cup carrying member can be stackable over a like planting cup carrying member;

The planting cup carrying member can be netstable within a like planting cup carrying member;

The planting cup carrying member can be configured at a top face thereof with an undulating or step-shaped or tooth-shaped pattern, with the cup openings disposed along each ridge;

The planting cup carrying member can be configured with longitudinally extending recesses, in which planting cups or seedlings can be positioned;

The longitudinal recesses can be configured with planting cup/seedling arresting edges extending from opposite side edges of a respective recess;

The longitudinal recesses can be configured at the planting cup/seedling arresting edges with resilient grips for gently supporting seedlings and/or planting cups. Such resilient grips can be, for example, bristles, sponge-like material, flexible holding finger members, etc.;

According to another aspect of the present disclosure there is a grow bed module, i.e. a water bed, configured for supporting one or more planting cup carrying members, wherein the water bed is made of a liquid impermeable material, configurable between a collapsed position and a deployed position, and further wherein said water bed is sustained at the erected position over a modular support truss.

Any one or more of the following features, designs and configurations can be incorporated in a water bed according to the present disclosure, solely or in various combinations thereof:

The water bed can be configured, at least at a top portion thereof, with a rectangular shape;

The water bed is suspended over truss;

At the deployed position, a bottom surface of the water bed is elevated from the ground;

The supporting truss can be modular and can be configured for supporting a plurality of water beds at different configurations thereof;

The water bed can be configured with one or more water inlet ports, outlet ports and drain ports, integrated therewith;

According to still an aspect of the present disclosure there is provided a filtration system for treating water of a hydroculture system, the filtration system comprising a filtering media received within a water treating container, said filtering media configured as a labyrinth-like flow path, whereby the filtered water flows along said flow path, and sediments carried with the water encounter the filtering media where they are prevented from exiting from the water bed and thus sink to the bottom of the water bed, whereby filtered water flows out of the container.

Any one or more of the following features, designs and configurations can be incorporated in a water filtration system according to the present disclosure, solely or in various combinations thereof:

The filtration media can integrally extend from inside side walls of the water treating container;

The filtration media can be configured as continuous pleated sheets of material disposed within the water treating container;

The pleated sheets of filtration media can be disposed substantially vertically within the water treating container, a top edge of said sheets defining a minimal water level within the water treating container;

The pleated sheets of filtration media can be disposed within the water treating container such that the folding edges face the flowing path;

The filtration system can comprise several one or more filtration units, disposed in series;

The filtration media can be made of sheets of polymeric material.

The disclosure, according to yet an aspect thereof, refers to a hydroculture system comprising one or more of:

A planting cup configured with a side wall formed with a plurality of openings and extending between an open bottom base and an open top base, wherein the planting cup is constructed out of a sheet of pliable material; and

A planting cup carrying member configured with a plurality of cup openings each for receiving therein a planting cup;

A water container configured for supporting at least one planting cup carrying member;

A control system;

An environment treating unit for controlling illumination, venting, temperature control; and

A water treating system.

The terms water treating system and water treatment system as used herein denote any one or more of a water circulating system, water filtration system, temperature controlling system, nutrient enriching system, water processing unit for controlling water PH, hardeness, oxidation, etc.

The hydroculture system can further comprise a water nutrient enriching unit in the form of a hydroponic water and nutrient supply unit, or an aquaponic fish tank, or a water nutrient generation bio-gas based unit, for receiving pumped water and for enriching the water with nutrients and supplying them; and a bio filter for filtering/capturing and biologically degrading pollutants from nutrient-rich water supplied by the water nutrient enriching unit and for supplying the filtered water to the planting cup carrying member.

The system can further comprise an electromechanical unit for facilitating oxidation and flowing the water in the planting cup carrying member. The electromechanical unit can comprise an air pump for collecting air from the environment and introducing it into the fluids in the planting cup carrying member. The air pump can be at least partially powered using green energy (e.g. solar, wind, geothermal electrical power source).

According to some embodiments of the present disclosure, the hydroculture system can be modular and may comprise two or more grow boxes that may be functionally connected, and/or disconnected, to each other as building blocks, to form a growing bed of a desirable size and shape.

Furthermore, the disclosure is directed to a method for hydroculture growing, the method comprising the following steps:

a) Obtaining a pliable sheet material being a development configured for constructing therefrom a planting cup configured with a side wall formed with a plurality of openings and extending between an open bottom base and an open top base, said development comprising a fastening mechanism for retaining a three dimensional shape of the constructed planting cup;

b) Shaping the pliable sheet material into a planting cup;

c) Setting the three dimensional shape by the fastening mechanism; and

d) Applying the planting cup into a planting cup carrying member.

### BRIEF DESCRIPTION OF THE DRAWINGS

In order to better understand the subject matter that is disclosed herein and to exemplify how it may be carried out in practice, embodiments will now be described, by way of non-limiting examples only, with reference to the accompanying drawings, in which:

FIG. 1A is a planar view of a pliable sheet material being a development configured for constructing therefrom a planting cup according to an aspect of the disclosure;

FIG. 1B is a side elevation of a planting cup erected out of the development of FIG. 1A;

FIG. 1C is a top perspective view of the planting cup of FIG. 1B;

FIG. 2A is a top perspective view of a planting cup configured with a retention threading;

FIG. 2B is a top view of the planting cup received within a cup opening of a planting cup carrying member;

FIG. 2C is a cross section along line II-II in FIG. 2C;

FIG. 3A is a side elevation of a planting cup configured with retention tabs;

FIG. 3B is a side elevation of a planting cup with its top and bottom edges disposed inclined with respect to a longitudinal axis of the planting cup;

FIG. 3C is a side elevation of yet another example of a planting cup according to the disclosure;

FIG. 4 is planar view of a development configured for constructing therefrom a planting cup according to a modification of the disclosure;

FIG. 5A is a planar view of a pliable sheet material being a development configured for constructing therefrom a polygonal planting cup;

FIG. 5B is a side elevation of a planting cup erected out of the development of FIG. 5A;

FIG. 5C is a top perspective view of the planting cup of FIG. 5B;

FIGS. 6A to 6D are planar views of a development configured for constructing therefrom a planting cup according to different embodiments of the disclosure;

FIG. 7A is a perspective view of a pliable coarse mesh sheet material being a development configured for constructing therefrom a planting cup according to an aspect of the disclosure;

FIG. 7B is an intermediate step of erecting a planting cup out of the sheet material of FIG. 7A;

FIG. 7C is a top perspective view of the planting cup made out of the sheet material of FIG. 7A;

FIG. 8A is a top perspective view of a planting cup/seeding carrying member according to an example of the disclosure;

FIG. 8B is a bottom view of the planting cup/seedling carrying member of FIG. 8A, with plants fitted therein;

FIG. 8C is a partial section along line VIII-VIII in FIG. 8A, with a seedling;

FIG. 8D is the same as FIG. 8A, however illustrating a plurality of seedlings distributed therein;

FIG. 8E is an enlargement of a portion of a planting cup carrying member according to another example, illustrating a seedling held thereby;

FIGS. 9A and 9B are a perspective top and bottom view, of a planting cup carrying member according to another example;

FIG. 9C is a side view of a corner portion of the planting cup carrying member of FIG. 9A, with a seedling in a planting cup received therein;

FIGS. 10A and 10B are a side view and a top perspective view of a pliable hydroculture water container, at its collapsed state, according to an aspect of the present disclosure;

FIGS. 11A and 11B illustrate the hydroculture water container of FIGS. 11 at a deployed position;

FIG. 12A is an exploded perspective view of the container of FIGS. 11 and a support truss there for;

FIG. 12B is a top perspective view of a deployed hydroculture water container;

FIG. 13A is top perspective view of a hydroculture system module, comprising a water bed with planting cup carrying member fitted thereover;

FIG. 13B is a perspective illustration of a hydroculture system module of FIG. 13A, further comprising a water treating system;

FIG. 13C is a perspective illustration of a hydroculture system of FIG. 13B, further comprising a fish tank module and a biogas unit;

FIG. 13D is a perspective illustration of a hydroculture system of FIG. 13C, comprising two water beds;

FIG. 13E illustrates a truss supporting a plurality of hydroculture system modules;

FIG. 14 is a top view of hydroculture system of FIG. 13C, illustrating a water flow path through the system;

FIGS. 15A to 15G illustrate a filtration system for use in conjunction with a hydroculture system, wherein:

FIG. 15A is a side view of the filtration system;

FIG. 15B is a top view of the filtration system;

FIG. 15C is a side view with side walls made transparent for sake of clarity;

FIG. 15D is a top perspective view of the filtration system;

FIGS. 15E and 15F are perspective top front and rear views, respectively, of the filtration system; and

FIG. 15G a perspective view with side walls made transparent for sake of clarity.

### DETAILED DESCRIPTION OF EMBODIMENTS

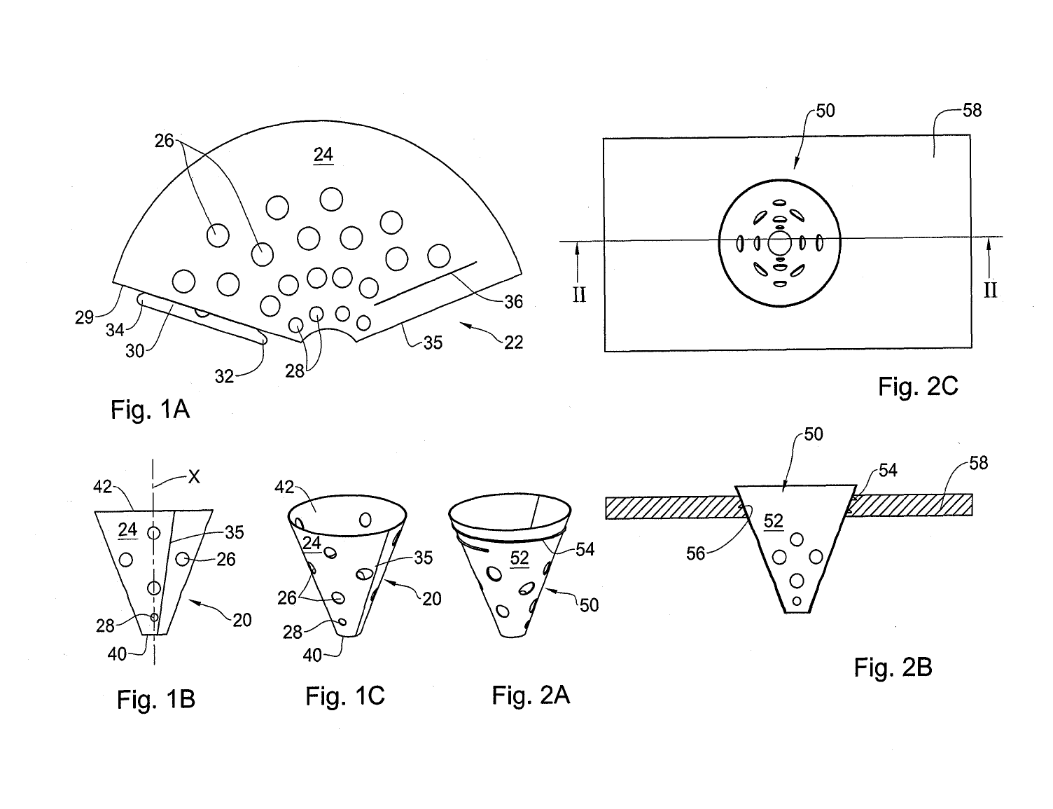

Attention is first directed to FIGS. 1 to 7, directed to a planting cup according to a first aspect of the present disclosure.

A first planting cup 20 is shown in FIGS. 1A-1C, wherein FIG. 1A illustrates a development of a sector 22 for preparing the three dimensional frustum cone-shaped planting cup 20 (FIGS. 11B and 1C). The development is made of a sheet of pliable though rigid material, made for example, of Polypropylene (PP), Polyvinyl chloride (PVC), etc. The sheet material of development can be made of, or comprise, recycled material and it can be homogeneous material or it can be composite material, or reinforced material.

The development 22 is configured with a plurality of radically positioned apertures 26, of which apertures 28 disposed along shorter radii, are of smaller diameter.

The development 22 further comprises fastening mechanism comprising a locking tab 30 extending along one side radii 29 of the development 22, said tab 30 having an extended bottom end 32 and a rounded top end 34. An arresting slit 36 is cut adjacent an opposite side radii 35 of the development 22. The length of the slit 36 is approximately similar to the length of the tab 30, along the attached portion marked 1.

The shape of development 22, with at least some of its formations (e.g. apertures 26 and 28), and elements of the fastening mechanism (tab 30 and slit 35) can be formed by injection molding or by puncturing.

Deploying/erecting the cone shaped planting cup 20 out of the development 22 takes place by rolling the side ends 29 and 35 towards one another and retaining the frustum cone shape by the fastening mechanism, namely inserting tab 30 into slit 36 (FIGS. 1B and 1C). The erected planting cup 20 is thus configured with a side wall 24 formed with a plurality of openings 26; 28, and extending between an open bottom base 40 and a larger open top base 42, said bases extending normal to a longitudinal axis X of the planting cup 20, in a symmetric fashion (FIG. 1B)

Knocking down the three dimensional shape is easily facilitated, even using one hand only, simply by deforming the cone such that the top end 34 of tab 30 disengages from the slit 35, resulting in the material spontaneously gaining its flat development shape. It is appreciated that this can occur also when a root base of a seeding received in the planting cup exceeds a standard size, whereby the roots are not strangled.

Turning now to FIGS. 2A to 2C, there is illustrated a planting cup generally designated 50, similar to planting cup 20 of in FIG. 1C, however wherein an outside surface 52 is configured at a top portion thereof with a projecting thread portion 54. The thread portion 54 serves as a securing mechanism for removably securing the planting cup 50 within a respective cup opening 56 configured at a planting cup carrying member 58 (FIG. 2B).

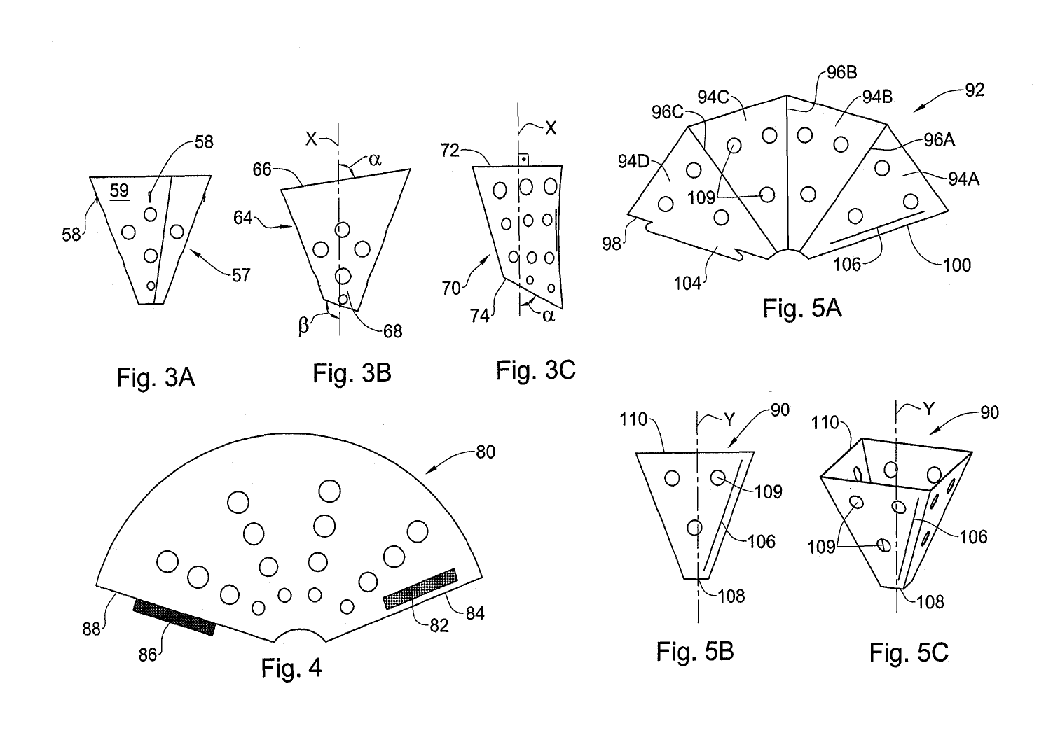

In FIG. 3A a securing mechanism for removably securing a planting cup 57 within a cup opening of a planting cup carrying member (not shown) can be a snap-type engagement, such as by tabs 58 outwardly projecting from an outside surface 59 of the planting cup 57. Other securing mechanisms (not shown can be configured, e.g. friction engagement, etc.

It is appreciated that according to other examples, a planting cup according to the disclosure can assume different shapes and modifications, e.g.: the planting cup can have a cylindrical shape (i.e. open bottom base and an open top base of similar diameter), not shown. Likewise, the planting cup can be symmetric or asymmetric about the longitudinal axis extending between the top base and the bottom base. In the example of FIG. 3B the planting cup 64 is a frustum cone, wherein the top base 66 extends inclined at α° and the bottom base 68 extends inclined (oblique) at β°, with respect to a longitudinal axis X, wherein α° can be equal or not to β°. Another example is illustrated in FIG. 3C, wherein the frustum cone-shaped planting cup generally designated 70 is configured such that a top base 72 extends substantially normal to the longitudinal axis X and a bottom base 74 is disposed at α° with respect to a longitudinal axis X.

In FIG. 4 there is illustrated a development generally designated 80 and substantially similar to development 22 of FIG. 1A, wherein the fastening mechanism is a hook and loop fastener with a hook portion 82 adjacent one side edge 84 of the development, and a loop portion 86 fastener adjacent an opposite side edge 88 of the development. The fastening mechanism can also be an adhesive agent, magnetic elements, etc, whereby the sheet material can be readily constructed into the three dimensional planting cup and easily be flattened.

The arrangement of the fastener mechanism can be such that only little force is required to open the fastening mechanism, to the extent that a developing root system can disengage the fastening mechanism, allowing expansion of the inside space of the planting cup.

The three dimensional planting cup can have a polyhedron shape, e.g. a frustum pyramid 90, as illustrated in FIGS. 5B and 5C. Such a planting cup 90 is formed out of a polygonal development 92 illustrated in FIG. 5A, comprising four planes 94A-94D with fold lines 96A-96C therebetween, respectively, and side edges 98 and 100. Development 92 further comprises a fastening mechanism comprising a locking tab 104 extending along side edge 98, and an arresting slit 106 cut adjacent the opposite side edge 100, similar to the arrangement of FIG. 1A. The development 92 is further formed with a plurality of root openings 109 disposed over surfaces of planes 94A-94D.

Upon folding the development 92 about the fold lines 96A-96C, the three dimensional planting cup 90 is obtained, having a frustum polygonal pyramid shape having a rectangle bottom base 108 and a greater rectangle top base 110, symmetrically extending about a longitudinal axis Y.

It is appreciated that a conical planting cup requires a circular opening formed at the planting cup carrying member, whilst for the polygonal cup a rectangle opening is required, respectively. However, a conical planting cup can be positioned within a cup opening having a rectangular shape with an appropriate inscribed circle, and likewise a polygonal planting cup can be positioned within a planting opening having an appropriate circumcircle.

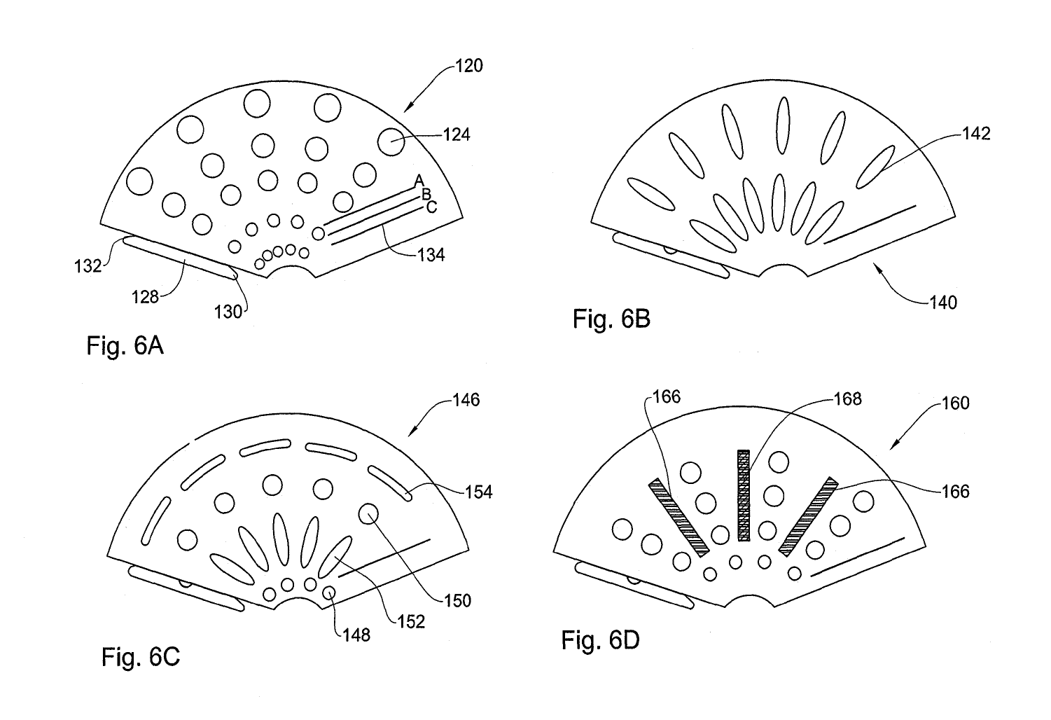

In FIG. 6A there is illustrated a sector-shaped development 120 similar to that disclosed in connection with FIG. 1A, however it comprises an array of root openings 124 disposed about imaginary radiuses of the development, wherein the size of the openings progressively increases further from the center. Furthermore, the developments comprises a single locking tab 128 having an extended bottom end 130 and an extended top end 132, configured for arresting with one of a plurality three arresting slits 134A-134C. This arrangement facilitates forming planting cups of different size, for use with seedlings of different size. The tab 128 in this example requires relative attention in detaching from a respective slit, owing to the provision of the double extended edges of the tab 132 (bottom end 130 and top end 132).

FIG. 6B illustrates yet an example of a sector-shaped development 140, principally similar to that disclosed in connection with FIG. 1A, however wherein the root openings 142 are configured as longitudinal openings disposed about imaginary radii of the development. In this connection it should be appreciated that the root openings configured at the sheet material can assume any size and shape, e.g. circular, polygonal, elongate apertures, etc. and can be disposed at different orientation and dispersion over the sheet material. As an example, FIG. 6C illustrates a development 146 of similar construction as discussed hereinbefore, however wherein the root openings are configured as small circular openings 148, larger circular openings 150, radially extending slots 152 and tangentially extending slots 154

Turning now to FIG. 6D, there is illustrated still a modification of a sector-shaped development 160, principally similar to that disclosed in connection with FIG. 1A, with the difference residing in the provision of two friction enhancing surfaces 166 configured for frictionally engaging within an inside face of cup opening of a planting cup carrying member. The frication enhancing surfaces can be integral with the development (e.g. formed by etching, stamping or during molding), or it ca be a patch applied thereover. Furthermore, the development 160 comprises a patch 168 impregnated with different agents, such as anti pesticides, antifungal, UV retarding agents, hydrophobic agents, anti-algae agents, bio-film preventing agents (i.e. for preventing microbial or other living substances), anti bacteria agents, anti fugal agents, etc. nano-hydrophobic coating, disinfecting agents (e.g. chemical disinfectants), etc.

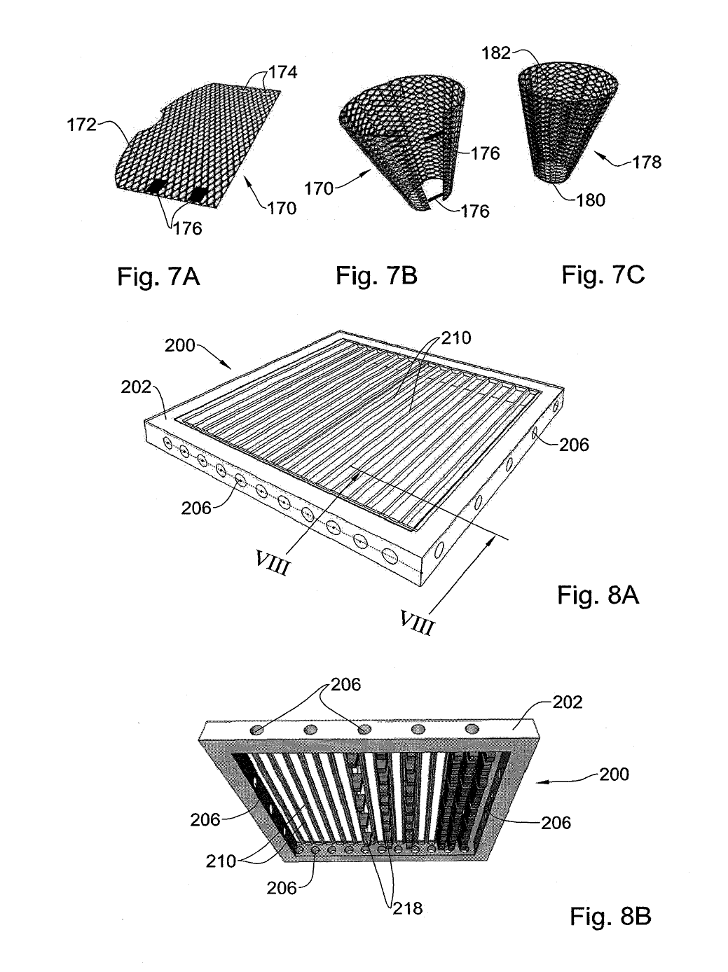

FIGS. 7A-7C illustrate a development 170 (FIG. 7A) made of rigid though pliable mesh-like material configured with a plurality of openings 172 (the density, shape and size of which can change) and two arresting openings 174 for engaging by arresting fasteners 176, whereby folding the development 170 (FIG. 7B) and fastening the fasteners within openings 174 gives rise to a frustum cone shaped planting cup 178 (FIG. 7C), having a small bottom base 180 and a greater top base 182.

It is noted that the planting cups discussed herein are configured such that the bottom opening thereof is configured to allow projection of substantially water roots, and the openings formed over the side wall of the planting cup are configured to allow projection of substantially air roots.

It is further noted that the planting cups are configured for nesting within like planting cups, and yet are easily flattened into stackable developments.

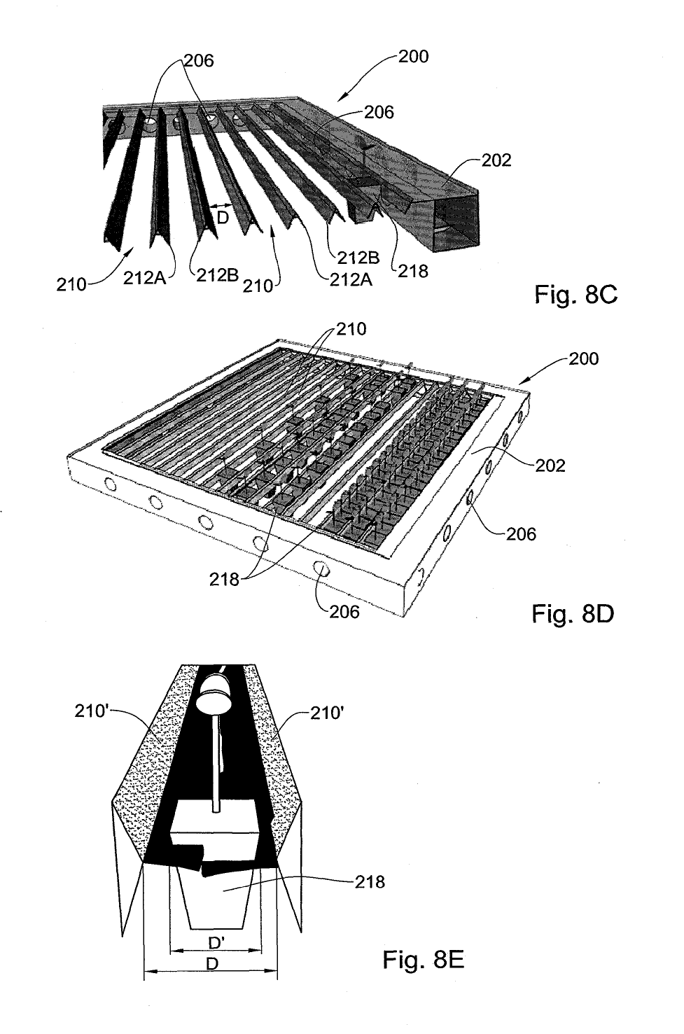

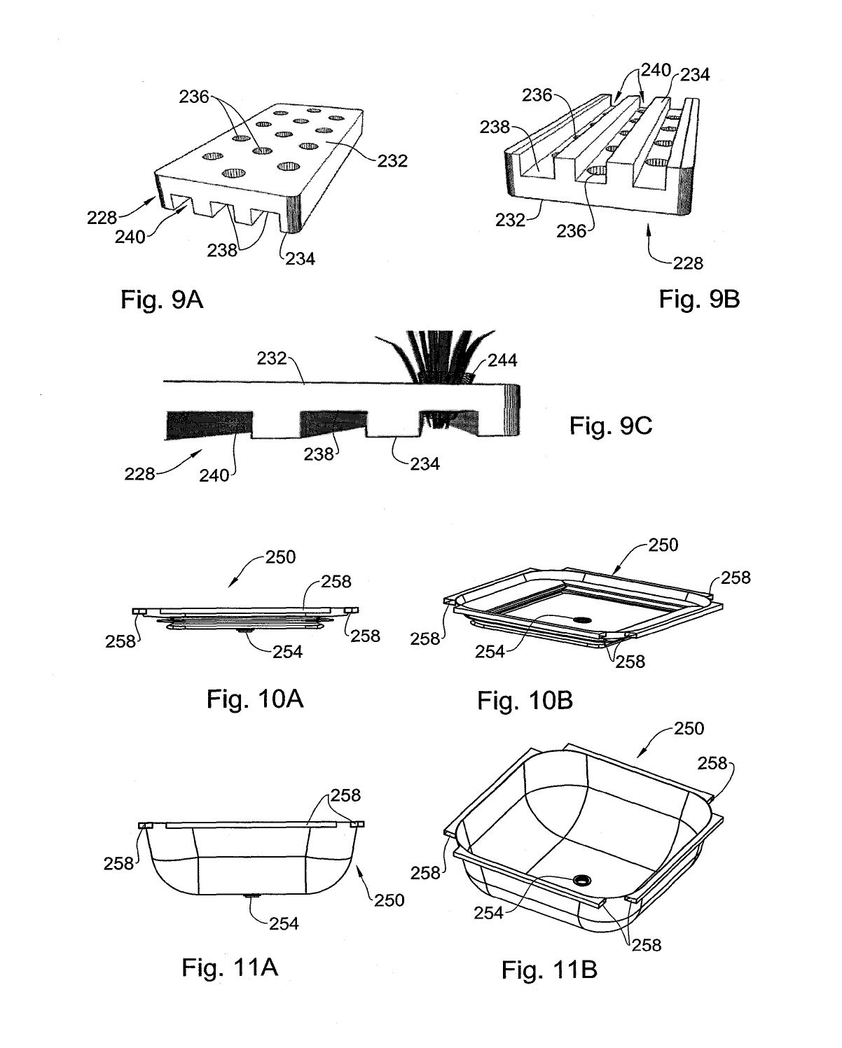

FIGS. 8 and 9 of the drawings are directed to a second aspect of the disclosure, namely to planting cup carrying members. These are frame-shaped elements configured for accommodating a plurality of planting cups and/or seedlings and placing over a water bed such that the planting cups and/or seedlings are maintained at a fixed predefined position with respect to the water surface, though the distance may be changing following growth progress of the plants.

The planting cup carrying members can comprise, e.g. adding during manufacture, by impregnation or by applying, different agents, such as anti pesticides, antifungal, UV retarding agents, hydrophobic agents, anti-algae agents, bio-film preventing agents (i.e. for preventing microbial or other living substances), anti bacteria agents, anti fugal agents, etc. nano-hydrophobic coating, disinfecting agents (e.g. chemical disinfectants), etc.

A first example of a planting cup carrying member is illustrated with reference to FIGS. 8A-8E wherein a planting cup carrying member generally designated 200 comprises a rectangular frame 202 made of rigid rectangular hollow profiles (see FIG. 8C) resulting in that the planting cup carrying member 200 will float over a water bed. The frame is configured with a plurality of venting ducts 206 extending through each side profile. Extending at an upper portion of the frame 202 there is a plurality of parallely disposed inverted V-shaped bars 210, with edges 212A and 212B of neighboring bars, spaced at a distance D from one another. This space constitutes a cup holding opening and can support planting cups (such as of the kind disclosed hereinbefore) and/or seadlings 218.

If required one or more bars 210 can be removed so as to control the distance D suitable for accommodating planting cups/seadlings of different size.

It can be seen that the venting ducts 206 extend below the bars 210, thus offering suitable air ventilation to the roots of any seadlings supported by the planting cup carrying member 200. The arrangement is such that air can be forced through the venting ducts 206, whereby even an array of like planting cup carrying members 200 provides adequate venting through the openings of the venting ducts 206, disposed in register (not shown).

A planting cup or seadling supported between neighboring bars of a cup opening can be easily placed and withdrawn. Even more so, at times it is required to increase the space between the seedlings, e.g. as the plants grow bigger, and this can be easily facilitated simply by sliding the seadlings along the bars.

In the example of FIG. 8E the V-shaped bars 210′, edges 212A and 212B of neighboring bars, are configured with brush-like bristles 220, whereby the effective distance is D′ and self adjusting to accommodate planting cups and seedlings of different size.

Turning now to FIGS. 9A-9C there is illustrated yet an example of a planting cup carrying member generally designated 228, made of a lighter than water material such as foamed material (e.g. Polyethylene, Polyurethane, etc.), and having a rectangular footprint.

The planting cup carrying member 228 is a planar member having top face 232 and a bottom face 234, with a plurality of circular cup openings 236 extending through said carrying member from the top face to a depressed bottom surface 238 (i.e. extending between the top face 232 and the bottom face 234). The channel 240 extending along the depressed surface, across the planting cup carrying member 228, constitutes an air flow passage extending at the vicinity of each cup opening 236.

The cup openings 236 configured at the illustrated planting cup carrying member 228 are cylindrical, though a tapering cross section can serve as well. Likewise, rather than circular the openings can be polygonal.

The arrangement is such that planting cups 244 (FIG. 9C) or seedlings can be easily placed and removed from said cup openings 236. The cup openings 236 can be selectively neutralized by applying a blocking cover (plug), to thereby allow spacing between neighboring active cup openings.

It is appreciated that the cup openings 236 of the planting cup carrying member 228 can be configured with a planting cup engagement arrangement, for securing a planting cup within a respective cup opening, such as snap/friction/threading engagement, as discussed herein above with reference to previous examples.

The flat design of the planting cup carrying member 228 renders them suitable for stacking over like planting cup carrying member.

The planting cup carrying members can be displaced floating over a water bed with steady height retained between a bottom face thereof and the water surface, resulting in controlled height of the planting cup/seeding and the roots, respectively. The planting cup carrying members can be secured within the water container so as to prevent their displacement (e.g. at the event of wind) and further, a plurality of planting cup carrying members can be adjoined to establish a continuous array of planting cup carrying members.

Further attention is now directed to FIGS. 10 to 15 of the drawings. First, with reference to FIGS. 10 and 11, there is illustrated a water container 250, made of pliable, water impermeable, opaque material, strong enough to bear the weight of a water body contained there within.

The material can be treated with different agents different agents, such as anti pesticides, antifungal, UV retarding agents, hydrophobic agents, anti-algae agents, bio-film preventing agents (i.e. for preventing microbial or other living substances), anti bacteria agents, anti fugal agents, etc., nano-hydrophobic coating, disinfecting agents (e.g. chemical disinfectants), etc.

The container 250 is configurable between a collapsible position, in a bellows-like fashion (FIGS. 10A and 10B), and a deployed position (FIGS. 11A and 11B), under its self weight. The effective size of the container, namely dimensions at the top portion thereof, are in conformity with the size of planting cup carrying members, facilitating placing one or more such planting cup carrying members to fully occupy/cover the container, thereby reducing water evaporation from the container and ingress of light, so as to reduce fungi grow therein.

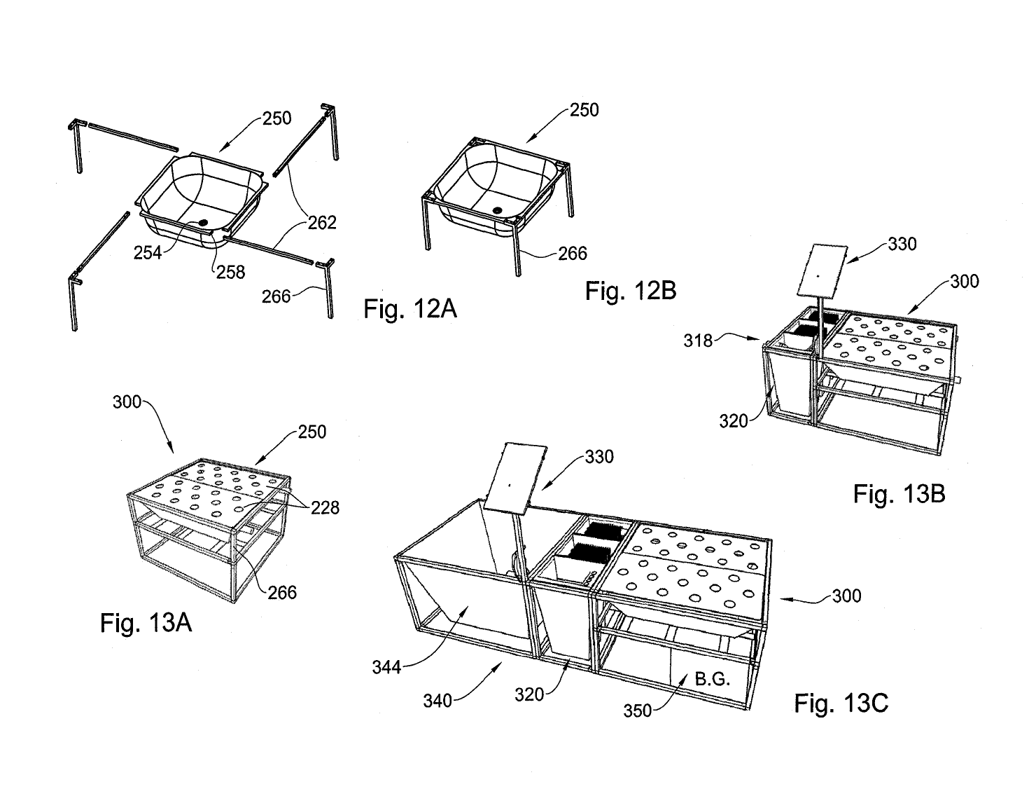

The container 250 has a general rectangle basin shape, substantially with rounded corners, and is configured at a bottom portion with a drain port 254, and at top edges there are configured sleeves 258 for receiving therein bars 262 of a modular support structure 264 (FIGS. 12), such that the container 250 can be suspended over posts 266 of the support structure, marinating its generally rectangular shape.

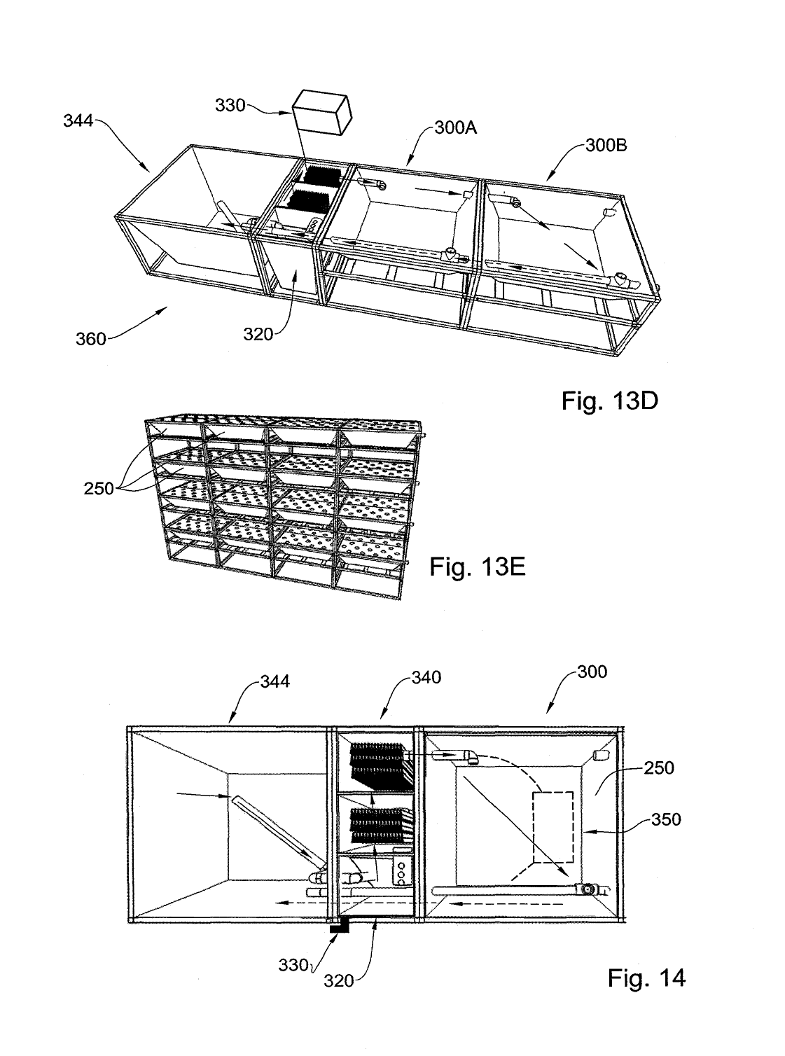

In FIG. 13A there is illustrated a top perspective view of a hydroculture system module generally designated 300, comprising a water bed (container) 250 as discussed herein above, with two planting cup carrying members 228 fitted thereover, wherein the container is suspended from the reinforced support frame, with sufficient space below the container. This is a basic module unit facilitating hydroculture grow.

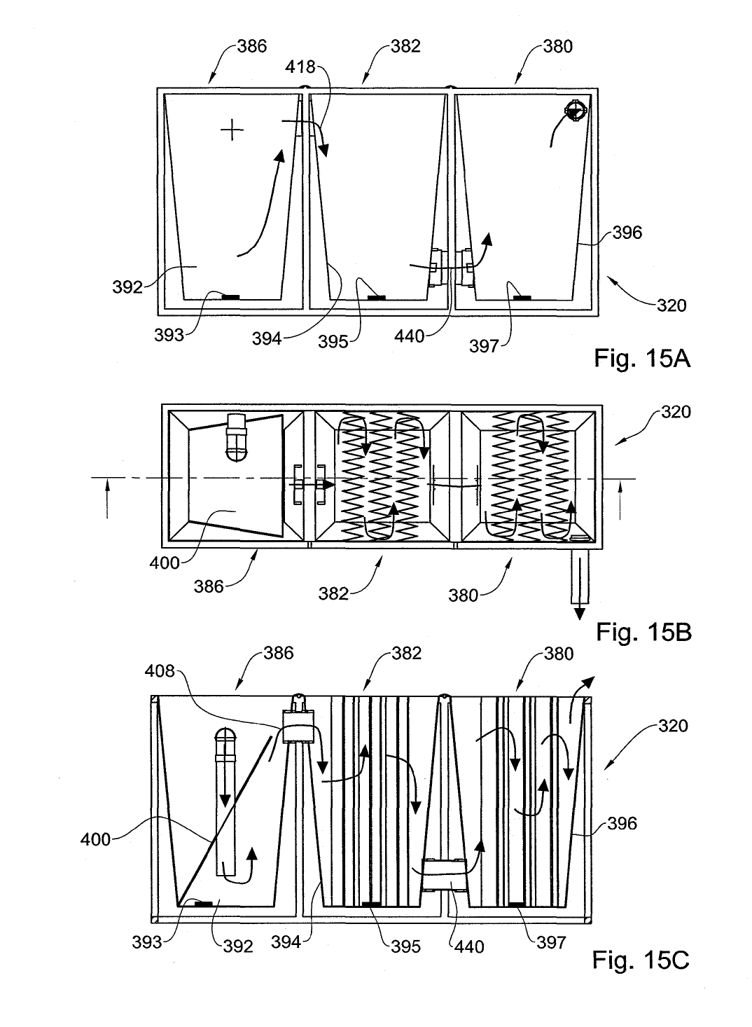

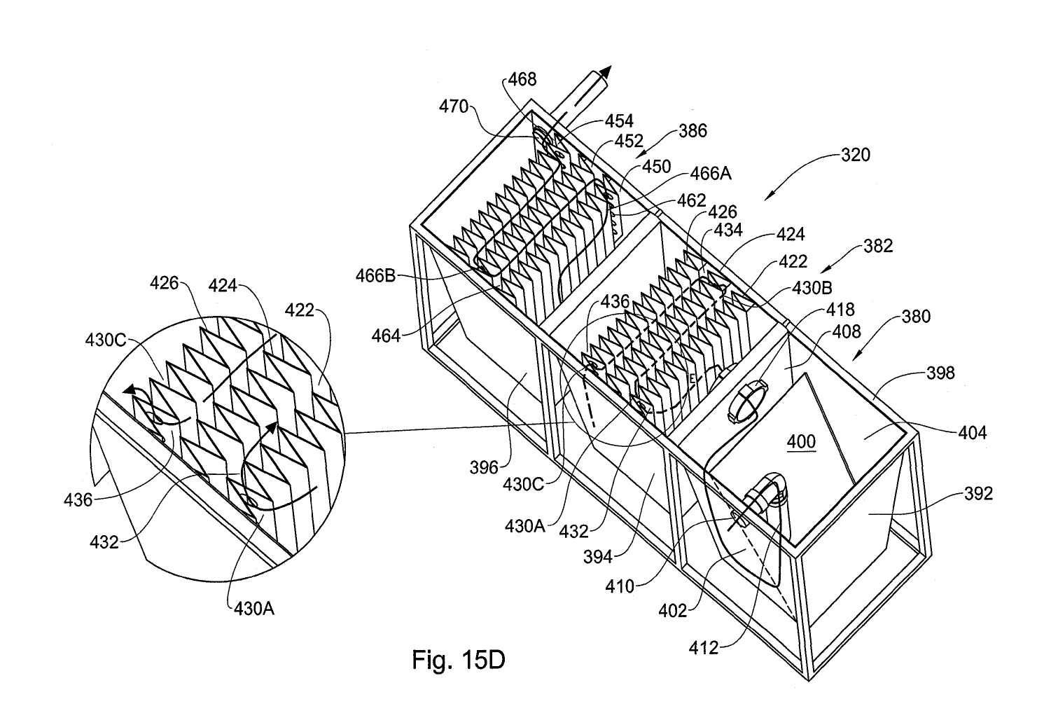

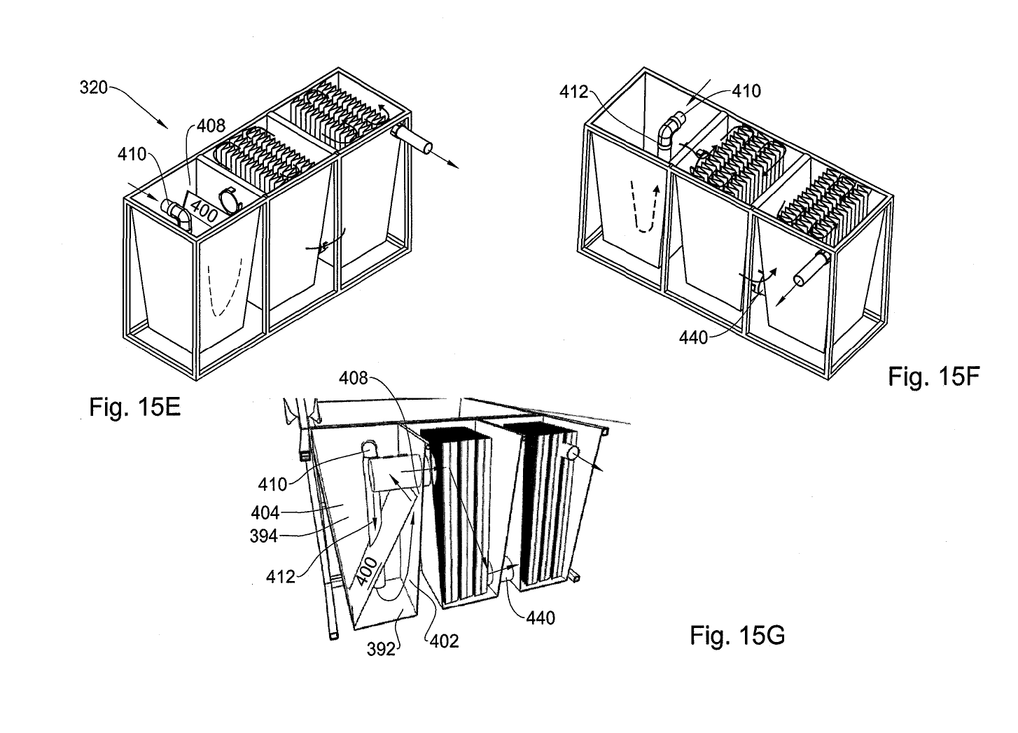

FIG. 13B illustrates an advanced hydroculture system generally designated 318, wherein the hydroculture system module 300 of FIG. 13A is associated with a water treating system generally designated 320, to which reference will be made in greater detail with reference to FIGS. 15 of the drawings. The system further comprises a control assembly generally designated 330, which can be associated with a processing unit, control panel, a solar power source, a plurality of sensors, water circulating units, water treating units (temperature, illumination, chemical properties controllers), etc, (not shown), fitted at different locations of the system 318.

In FIG. 13C there is illustrated a still advanced hydroculture system generally designated 340, wherein the hydroculture system module 300 (FIG. 13A) is associated with the water treating system 320 (FIGS. 13B and 15), a control assembly 330 (FIG. 13B) and further a fish tank module 344 is associated with the system 340, and a biogas enriching unit 350, the two later provided for enriching the water with nutritious agents. As can be seen also in FIG. 14 (top view of FIG. 13C; the planting cup carrying members removed), water is circulated from the fish tank 344 to the water treating system 320, then to the biogas enriching unit 350, into the water tank 300, and back to the fish tank 344. At the absence of a biogas enriching unit, water is circulated from the fish tank 344 to the water treating system 320, into the water tank 300, and back to the fish tank 344.

FIG. 13D illustrates modularity of the system generally designated 360, comprising, in addition to the components discussed with reference to FIG. 13C, an additional water tank, wherein water is circulated from the fish tank 344 to the water treating system 320, into the first water tank 300A, then to the second water container 300B, and back to the fish tank 344.

FIG. 13E illustrates how a plurality of water containers 250 can be supported in a space-efficient contracture over a modular supporting truss, wherein the water containers are in flow communication with neighboring containers and further with the water treating and enriching modules (not shown)

With attention now directed to FIGS. 15A to 15F reference is made to the water treating system, generally designated 320, comprising a sedimentation stage 380, a first filtration and sedimentation stage 382 and a second filtration and sedimentation stage 386. Each stage comprises a water tank 392, 394 and 396, respectively, made of flexible, water impermeable material, and suspended over a rigid support truss 398.

The sedimentation stage 380 comprises a sediment deflecting surface 400 disposed inclined within the water tank 392 and attached to side walls from a bottom edge thereof, so as to divide the tank 392 into a bottom chamber 402 and a top chamber 404, with a flow path therebetween extending at a top portion 408. An inlet port 410 extends into the water tank 392 with an inlet pipe 412 extending through the sediment deflecting surface 400 into the bottom chamber 402.

The first tank 392 is in flow communication with the second thank 394 via a flow pipe 418 configured at a top portion of these tanks.

Disposed within the first filtration and sedimentation stage 382 there is a filtration media in the form of three parallely disposed barriers 422, 424 and 426, made of a liquid impermeable sheet of material disposed in a pleated fashion within the tank 394, wherein side edges of each barrier are welded to the respective inside side walls of the tank 394. The first pleated barrier sheet 422 comprises at its left side panel 432 an array of openings 430A extending the length of said panel, the second pleated barrier sheet 424 comprises at its right side panel 434 an array of openings 430B extending the length of said panel, and the third pleated barrier sheet 426 comprises at its left side panel 436 an array of openings 430C extending the length of said panel.

The second tank 394 is in flow communication with the third thank 396 via a flow pipe 440 configured at a bottom portion of these tanks.

Similar to the arrangement of the first filtration and sedimentation stage 382, the second filtration and sedimentation stage 386 comprises a filtration media in the form of three parallely disposed barriers 450, 452 and 454, made of a liquid impermeable sheet of material disposed in a pleated fashion within the tank 396, wherein side edges of each barrier are welded to the respective inside side walls of the tank 396. The first pleated barrier sheet 450 comprises at its right side panel 462 an array of openings 466A extending the length of said panel, the second pleated barrier sheet 452 comprises at its right left panel 464 an array of openings 466B extending the length of said panel, and the third pleated barrier sheet 454 comprises at its right side panel 468 an array of openings 466C extending the length of said panel.

The third tank 386 is configured with an outlet port 470 disposed a top portion of the tank.

It is noted that each of the water tanks 392, 394 and 396 is configured at a bottom thereof with at least one draining port 393, 395 and 397, respectively. The flow pipes can be flexible hosed or detachably attachable, and furthermore, the tanks are made of flexible material such that they can be easily collapsed and be stowed away.

The arrangement is such that water entering the first tank 392 through inlet 410 flow directly into the bottom chamber 402 and through flow path 408 to the top chamber 404, wherein sediments sink to the bottom of the tank at bottom chamber 402 and at the top chamber 404, with overflowing water flowing through flow pipe 418 into the tank 394 of the first filtration and sedimentation stage 382. Water then encounters the first barrier 422 wherein sediments sink to the bottom of the tank or collect over the filtration media panels, wherein water can flow into the space between the first barrier 422 and the second barrier 424 only through openings 430A. here again, sediments are collected at the bottom of the tank and over panels of the first and second barriers 422 and 424, and water can now flow into the space between the second barrier 424 and the third barrier 426 only through openings 430B. Again, sediments sink to the bottom of the tank and collect over the panels of the second barrier 424 and the third barrier 426. Therefrom water flows through openings 430C into the space behind the third barrier 426 with sediments collecting at the bottom of the tank 394 and over back face of panels of the third barrier 426. The arrangement described forces the water to flow through a labyrinth type flow path so that slow water flow over the surfaces of the barrier panels removes any sediments from the water.

As water reached the space in the second tank 394 extending behind the third barrier 426 it flow through flow pipe 440 into the third tank 396 of second filtration and sedimentation stage 386. Within the third tank 396 water flow in the same manner as discussed hereinbefore in connection with the second tank 394 and as represented by thick dashed lines in the drawings, resulting in sedimentation of dirt and series and outflow over clean water through outlet port 470 disposed at the top of the third tank 396. It is appreciated that each chamber (extending between neighboring barriers or a barrier and a wall of the tank) can be configured at a bottom thereof with draining port extending to into the main draining ports 393, 395 and 397. Alternatively, each such camber can be configured with an independent draining port (not shown).

It is noted that each of the water tanks 392, 394 and 396 is configured at a bottom thereof with at least one draining port 393, 395 and 397

Noticeable, circulation of the water is facilitated by a pump (not seen) governed by the control unit.

1. A planting cup for hosting growing plants, for use in conjunction with hydroculture systems, said planting cup configured with a side wall formed with a plurality of openings and extending between an open bottom base and an open top base, wherein the planting cup is constructed out of a sheet of pliable material.

2. A planting cup according to claim 1, made of a liquid impermeable material.

3. A planting cup according to claim 1, having a frustum cone or frustum pyramid shape.

4. A planting cup according to claim 3, wherein the bottom base is smaller then the top base, wherein the side wall tapers towards the bottom base.

5. A planting cup according to claim 1, wherein having a cylindrical or polyhedron shape.

6. A planting cup according to claim 1, further comprising a fastening mechanism for retaining a three dimensional shape of the constructed planting cup.

7. A planting cup according to claim 6, wherein the fastening mechanism comprises one or more fastener flaps extending from one side of a development of the cup, and configured for arresting within one or more slits adjacent an opposite side of the development.

8. A planting cup according to claim 7, wherein the fastener flap and the slit are disposed parallel to respective side edges of the development of which the planting cup is made of.

9. A planting cup according to claim 7, wherein the length of the fastener flap is be greater than the length of the respective slit, with a projection at a bottom portion of the flap.

10. A planting cup according to claim 1, wherein an outside face thereof comprises a securing mechanism for removable securing it within a respective cup opening configured at a planting cup carrying member, thereby securely positioning the planting cup within the cup opening either at a vertical or inclined position.

11. A planting cup according to claim 10, wherein the securing mechanism is a threading configured at an outside face of the planting cup.

12. A planting cup according to claim 10, wherein the securing mechanism is a snap-type engagement configured at an outside face of the planting cup.

13. A planting cup according to claim 1, being nestable within like planting cups.

14. A pliable sheet material being a development of a planting cup for use in conjunction with hydroculture systems, said development configured for constructing therefrom a planting cup configured with a side wall formed with a plurality of openings and extending between an open bottom base and an open top base.

15. A planting cup carrying member, configured for removably retaining a plurality of planting cups or seedlings, said planting cup carrying member comprising a planar member having top face and a bottom face, with a plurality of cup openings disposed through said carrying member, each configured to support therein a planting cup, wherein the carrying member is further configured with a flotation arrangement for retaining a substantially fixed distance between the bottom face and a water bed surface, and further wherein an air flow passage extends at least at the bottom face of the vicinity of each cup opening.

16. A planting cup carrying member according to claim 15, wherein the planting cups and seedlings can be slidingly displaced within recessed cup openings.

17. A planting cup carrying member according to claim 15, wherein it is made of a board of material configured at a bottom face thereof with a channel extending between at least neighboring cup openings.

18. A planting cup carrying member according to claim 15, wherein the cup openings are disposed along a linear matrix, wherein a bottom face of the carrying member is configured with a flow channel extending along a linear path between respective opposite ends of the planting cup carrying member.

19. A planting cup carrying member according to claim 15, comprising a plurality of cup openings, at least some of which can be selectively neutralized by blocking.

20. A planting cup carrying member according to claim 15, wherein the cup openings configured at the board of material can be cylindrical or have a tapering cross section.

21. A planting cup carrying member according to claim 15, wherein the cup openings are configured with a planting cup engagement arrangement, for securing a planting cup within a respective cup opening.

22. A planting cup carrying member according to claim 15, comprising a plurality of parallely disposed bars, wherein planting cups or seedlings are receivable within longitudinally extending recesses between said bars.

23. A planting cup carrying member according to claim 22, wherein the longitudinal recesses are configured with arresting edges extending from opposite side edges of a respective recess.

24. A planting cup carrying member according to claim 23, wherein the arresting bars have an inverted V-like shape.

25. A planting cup carrying member according to claim 22, wherein the longitudinal recesses are configured at arresting edges with resilient grips for gently supporting seedlings and/or planting cups.

26. A grow bed module for a hydroculture system for supporting one or more planting cup carrying members, said grow bed module made of a liquid impermeable material and being configurable between a collapsed position and a deployed position, and further wherein said water bed is sustained at the erected position over a modular support truss.

27. A grow bed module according to claim 26, wherein the water bed, at its erected position, is suspended over a truss such that a bottom base thereof is elevated from the ground.

28. A filtration system for treating water of a hydroculture system, the filtration system comprising a filtering media received within a water treating container, said filtering media configured as a labyrinth-like flow path, whereby the filtered water flows along said flow path, and sediments carried with the water encounter the filtering media where they are prevented from exiting from the water bed and thus sink to the bottom of the water bed, whereby filtered water flows out of the container.

29. A filtration system according to claim 28, wherein the filtration media integrally extends from inside side walls of the water treating container.

30. A filtration system according to claim 28, wherein the filtration media are configured as continuous pleated sheets of material disposed within the water treating container.

31. A filtration system according to claim 28, wherein the pleated sheets of filtration media are disposed substantially vertically within the water treating container, a top edge of said sheets defining a minimal water level within the water treating container.

32. A filtration system according to claim 28, wherein the pleated sheets of filtration media can be disposed within the water treating container such that the folding edges face the flowing path.

33. A filtration system according to claim 28, comprising a plurality of filtration units, disposed in series.

34. A filtration system according to claim 28, wherein the filtration media is made of sheets of polymeric material.

35. A hydroculture system comprising one or more of:
a) A planting cup configured with a side wall formed with a plurality of openings and extending between an open bottom base and an open top base, wherein the planting cup is constructed out of a sheet of pliable material;
b) A planting cup carrying member configured with a plurality of cup openings each for receiving therein a planting cup;
c) A water container configured for supporting at least one planting cup carrying member;
d) A control system;
e) An environment treating unit for controlling illumination, venting, temperature control; and
f) A water treating system.

36. A hydroculture system according to claim 35, further comprising a water nutrient enriching system in the form of a hydroponic water and nutrient supply unit, or an aquaponic fish tank, or a water nutrient generation bio-gas based unit, for receiving pumped water and for enriching the water with nutrients and supplying them; and a bio filter for filtering/capturing and biologically degrading pollutants from nutrient-rich water supplied by the water nutrient enriching unit and for supplying the filtered water to the planting cup carrying member.

37. A hydroculture system according to claim 35 further comprising a fluid propelling unit for oxidation and flowing the water in the planting cup carrying member.

38. A method for hydroculture growing, the method comprising the following steps:
(a) Obtaining a pliable sheet material being a development configured for constructing therefrom a planting cup configured with a side wall formed with a plurality of openings and extending between an open bottom base and an open top base, said development comprising a fastening mechanism for retaining a three dimensional shape of the constructed planting cup;
(b) Shaping the pliable sheet material into a planting cup;
(c) Setting the three dimensional shape by the fastening mechanism; and
(d) Applying the planting cup into a planting cup carrying member.
